(19) United States
(12) Patent Application Publication
(10) Pub. No.: US 2026/0253967 A1
(43) Pub. Date: Aug. 27, 2026

(54) ALL-SOLID-STATE BATTERY AND METHOD OF MANUFACTURING ALL-SOLID-STATE BATTERY

(71) Applicant: HONDA MOTOR CO., LTD., Tokyo (JP)

(72) Inventors: Tatsuya HASHIMOTO, Saitama (JP); Atsuhiro NISHIDA, Saitama (JP); Hiroshi AKUTSU, Saitama (JP); Sachio SUZUKI, Saitama (JP); Daichi TANAKA, Saitama (JP); Takashi TOMIDA, Saitama (JP); Kenta KASANO, Saitama (JP); Takahiro IMAJO, Saitama (JP); Shigeyuki KOBAYASHI, Saitama (JP); Kyoka ITASAKA, Saitama (JP)

(21) Appl. No.: 19/547,691

(22) Filed: Feb. 24, 2026

(30) Foreign Application Priority Data
Feb. 25, 2025 (JP) 2025-028315

(51) Int. Cl. H01M 10/0585; C09J 5/00; H01M 10/42; H01M 50/586; H01M 50/59

(52) U.S. Cl. CPC H01M 10/0585; C09J 5/00; H01M 10/4235; H01M 50/586; H01M 50/59; C09J 2203/33; C09J 2400/126

(57) ABSTRACT

Provided are an all-solid-state battery capable of improving battery characteristics and a method of manufacturing the all-solid-state battery. An all-solid-state battery 1 includes a negative electrode layer 10 and a positive electrode layer 20 laminated together with a solid electrolyte layer 30 interposed therebetween, the positive electrode layer 20 having a positive electrode active material layer 25. An insulating layer 26 is provided along an outer periphery of the positive electrode active material layer 25. The all-solid-state battery 1 includes an adhesive layer 50 provided between the insulating layer 26 and the solid electrolyte layer 30 that are adjacent to each other.

### CROSS-REFERENCE TO RELATED APPLICATIONS

This application is based on and claims the benefit of priority from Japanese Patent Application No.2025-028315, filed on 25 February 2025, the content of which is incorporated herein by reference.

### BACKGROUND OF THE INVENTION

### Field of the Invention

The present invention relates to an all-solid-state battery and a method of manufacturing an all-solid-state battery.

### Related Art

In recent years, research and development of secondary batteries that contribute to energy efficiency has been carried out in order to ensure many people have access to affordable, reliable, sustainable, and advanced energy.

Among the secondary batteries, all-solid-state batteries including a solid electrolyte are particularly receiving attention because they have an excellent feature of providing high safety due to the non-flammable nature of the solid electrolyte and having higher energy density. Studies are being conducted on an all-solid-state battery that has a laminated structure in which a plurality of positive electrode layers and negative electrode layers are alternately laminated with solid electrolyte layers interposed therebetween (for example, Japanese Unexamined Patent Application, Publication No. 2023-47083).

In Japanese Unexamined Patent Application, Publication No. 2023-47083, the positive electrode layer is formed by laminating a positive electrode current collector layer and a positive electrode active material layer. An insulating frame is provided along an outer periphery of the positive electrode active material layer in order to suppress occurrence of a short circuit. The insulating frame faces the solid electrolyte layer.

Patent Document 1: Japanese Unexamined Patent Application, Publication No. 2023-47083

### SUMMARY OF THE INVENTION

The insulating frame and the solid electrolyte layer are composed of relatively hard materials, respectively. The solid electrolyte layer is likely to slip with respect to the insulating frame. When the solid electrolyte layer is laminated on the positive electrode layer, the solid electrolyte layer may slip with respect to the insulating frame, and the positional relationship between the solid electrolyte layer and the positive electrode layer may deviate from an ideal positional relationship. In such a case, electrical resistance between the positive electrode layer and the solid electrolyte layer increases, and battery characteristics of the all-solid-state battery may deteriorate.

It is an object for the present invention to provide an all-solid-state battery capable of improving battery characteristics and a method of manufacturing the all-solid-state battery.

(1) A first aspect of the present invention is directed to an all-solid-state battery including: a negative electrode layer and a positive electrode layer laminated together with a solid electrolyte layer interposed therebetween, the positive electrode layer having a positive electrode active material layer; an insulating layer provided along an outer periphery of the positive electrode active material layer; and an adhesive layer provided between the insulating layer and the solid electrolyte layer that are adjacent to each other.

According to the all-solid-state battery described in (1), the adhesive layer is interposed between the insulating layer and the solid electrolyte layer, whereby the likelihood that the insulating layer slips with respect to the solid electrolyte layer can be reduced or eliminated. This makes it possible to reduce or eliminate the likelihood that the positional relationship between the solid electrolyte layer and the positive electrode active material layer deviates from an ideal positional relationship, whereby an increase in electrical resistance between the solid electrolyte layer and the positive electrode active material layer can be suppressed. Therefore, it is possible to provide an all-solid-state battery 1 capable of improving battery characteristics.

(2) According to a second aspect, in the all-solid-state battery described in (1) above, the insulating layer may be composed of alumina.

According to the all-solid-state battery described in (2), since alumina is a material having low electrical conductivity, the insulating performance of the insulating layer can be improved. This makes it possible to satisfactorily reduce or eliminate the likelihood of occurrence of a short circuit between the negative electrode layer and the positive electrode layer when the negative electrode layer (negative electrode tab) is curved and comes into contact with the insulating layer. In the case of being composed of alumina, the insulating layer is relatively hard and may tend to slip with respect to the solid electrolyte layer. However, the action of the adhesive layer reduces or eliminates the likelihood that the insulating layer slips with respect to the solid electrolyte layer, whereby the use of alumina as a material for the insulating layer can be facilitated.

(3) According to a third aspect, in the all-solid-state battery described in (1) or (2) above, a direction in which the negative electrode layer and the positive electrode layer are laminated with the solid electrolyte layer interposed therebetween is defined as a laminating direction, one direction among directions orthogonal to the laminating direction is defined as a first direction, and a direction orthogonal to the laminating direction and the first direction is defined as a second direction, the positive electrode active material layer may have a long-side direction corresponding to the first direction, the insulating layer may have a first side portion extending in the second direction, and the adhesive layer may be provided at least between the first side portion and the solid electrolyte layer.

The all-solid-state battery described in (3) makes it possible to sufficiently reduce or eliminate the likelihood that the solid electrolyte layer slips with respect to the insulating layer. Therefore, as a result, the likelihood that the positional relationship between the solid electrolyte layer and the positive electrode layer deviates from an ideal positional relationship is reduced.

(4) According to a fourth aspect, in the all-solid-state battery described in (1) or (2) above, the adhesive layer may be provided only between the first side portion and the solid electrolyte layer.

The all-solid-state battery described in (4) makes it possible to reduce an amount of the adhesive layer to be used, while sufficiently reducing or eliminating the likelihood that the solid electrolyte layer slips with respect to the insulating layer.

(5) According to a fifth aspect, in the all-solid-state battery described in (3) above, the insulating layer may have a second side portion that is adjacent to the first side portion in the first direction and extends in the first direction, and the adhesive layer may be provided between the second side portion and the solid electrolyte layer.

The all-solid-state battery described in (5) makes it possible to more reliably reduce or eliminate the likelihood that the solid electrolyte layer slips with respect to the insulating layer.

(6) According to a sixth aspect, in the all-solid-state battery described in any one of (1) to (5) above, the adhesive layer may be provided in a shape of a dot.

The all-solid-state battery described in (6) makes it possible to reduce an amount of the adhesive layer to be used, while sufficiently reducing or eliminating the likelihood that the solid electrolyte layer slips with respect to the insulating layer.

(7) According to a seventh aspect, in the all-solid-state battery described in (1) above, a direction in which the negative electrode layer and the positive electrode layer are laminated with the solid electrolyte layer interposed therebetween is defined as a laminating direction, and a recessed portion that is recessed in the laminating direction may be formed in a portion of the insulating layer that overlaps with the adhesive layer in the laminating direction.

The all-solid-state battery described in (7) makes it easy to bring the positive electrode active material layer into contact with the solid electrolyte layer in a state in which the adhesive layer is in contact with the solid electrolyte layer, thereby facilitating transfer of electrons between the positive electrode active material layer and the solid electrolyte layer.

(8) According to an eighth aspect, in the all-solid-state battery described in (1) above, a dimension in the laminating direction of a recessed portion may be 65% or more and 100% or less of a dimension in the laminating direction of the insulating layer.

When the dimension in the laminating direction of the insulating layer is small, the strength of the insulating layer may decrease. When the dimension in the laminating direction of the adhesive layer is small, the strength of the adhesive layer may decrease. However, the all-solid-state battery described in (8) makes it possible to ensure both the strength of the insulating layer and the strength of the adhesive layer.

(9) A ninth aspect is directed to a method of manufacturing the all-solid-state battery described in (1) above, the method including: a preparation step including preparing an insulating layer-equipped positive electrode layer that has the positive electrode active material layer and the insulating layer provided along the outer periphery of the positive electrode active material layer; an adhesive layer disposing step including disposing the adhesive layer on a surface of the insulating layer; a solid electrolyte layer disposing step including laminating the solid electrolyte layer on a surface of the insulating layer-equipped positive electrode layer; and a negative electrode layer disposing step including disposing the negative electrode layer on a surface of the solid electrolyte layer opposite to the positive electrode layer.

According to the method described in (9), the insulating layer is disposed on the surface of the positive electrode layer to form the insulating layer-equipped positive electrode layer, and the solid electrolyte layer is disposed on the surface of the insulating layer-equipped positive electrode layer, whereby the likelihood that the positional relationship between the solid electrolyte layer and the positive electrode active material layer deviates from an ideal positional relationship can be reduced or eliminated. As a result, an increase in electrical resistance between the solid electrolyte layer and the positive electrode active material layer can be suppressed, whereby the provided method of manufacturing an all-solid-state battery is capable of improving battery characteristics.

(10) According to the tenth aspect, in the method described in (9) above, in the solid electrolyte layer disposing step, a direction in which the negative electrode layer and the positive electrode layer are laminated with the solid electrolyte layer interposed therebetween is defined as a laminating direction, one direction among directions orthogonal to the laminating direction is defined as a first direction, and a direction orthogonal to the laminating direction and the first direction is defined as a second direction,

the preparation step may include preparing the positive electrode active material layer having a long-side direction corresponding to the first direction and the insulating layer having a first side portion extending in the second direction, and the adhesive layer disposing step may include disposing the adhesive layer at least on the first side portion.

The method described in (10) makes it possible to manufacture the all-solid-state battery capable of sufficiently reducing or eliminating the likelihood that the solid electrolyte layer slips with respect to the insulating layer.

(11) According to an eleventh aspect, in the method described in (10) above, the adhesive layer disposing step may include disposing the adhesive layer only on the first side portion.

The method described in (11) makes it possible to reduce an amount of the adhesive layer to be used, while manufacturing the all-solid-state battery capable of sufficiently reducing or eliminating the likelihood that the solid electrolyte layer slips with respect to the insulating layer.

(12) According to a twelfth aspect, in the method described in (10) above, the preparation step may include preparing the insulating layer-equipped positive electrode layer such that the insulating layer has a second side portion adjacent to the first side portion in the first direction and extending in the first direction, and the adhesive layer disposing step may include disposing the adhesive layer on the second side portion.

The method described in (12) make it possible to manufacture an all-solid-state battery capable of more reliably reducing or eliminating the likelihood that the solid electrolyte layer slips with respect to the insulating layer.

(13) According to a thirteenth aspect, the method described in any one of (9) to (12) above may further include a positive electrode winding step including winding, around a roll, a laminate including the solid electrolyte layer and the positive electrode layer having the insulating layer that are laminated with the adhesive layer interposed between the insulating layer and the solid electrolyte layer.

The method described in (13) makes it possible to efficiently manufacture the all-solid-state battery. On the other hand, in a case of winding the laminate of the solid electrolyte layer and the positive electrode layer around a roll in order to manufacture a plurality of all-solid-state batteries, if the positional relationship between the solid electrolyte layer and the positive electrode layer deviates from an ideal positional relationship, it may become difficult to wind the laminate of the solid electrolyte layer and the positive electrode layer around the roll. However, by interposing the adhesive layer between the insulating layer and the solid electrolyte layer, the deviation of the positional relationship between the solid electrolyte layer and the positive electrode layer can prevented or reduced, whereby the laminate of the solid electrolyte layer and the positive electrode layer can be easily wound around the roll. This makes it possible to manufacture an all-solid-state battery more efficiently.

The present invention can provide an all-solid-state battery capable of improving battery characteristics.

The present invention can provide a method of manufacturing an all-solid-state battery capable of improving battery characteristics.

### BRIEF DESCRIPTION OF THE DRAWINGS

FIG. 1 is an external perspective view of an all-solid-state battery according to an embodiment;

FIG. 2 is a cross-sectional view of the all-solid-state battery taken along line II-II in FIG. 1;

FIG. 3 is a cross-sectional view of the all-solid-state battery taken along line III-III in FIG. 1;

FIG. 4 is an exploded perspective view of the all-solid- state battery;

FIG. 5 is a plan view of a positive electrode layer viewed in a laminating direction;

FIG. 6 is a plan view of a positive electrode layer having an adhesive layer laminated thereon, viewed in the laminating direction;

FIG. 7 is a flowchart illustrating a method of manufacturing the all-solid-state battery according to the embodiment;

FIG. 8 is a plan view of a positive electrode layer on which an adhesive layer according to a modification is laminated, viewed in the laminating direction;

FIG. 9 is a plan view of a positive electrode layer on which an adhesive layer according to a modification is laminated, viewed in the laminating direction; and

FIG. 10 is a plan view of a positive electrode layer on which an adhesive layer according to a modification is laminated, viewed in the laminating direction.

### DETAILED DESCRIPTION OF THE INVENTION

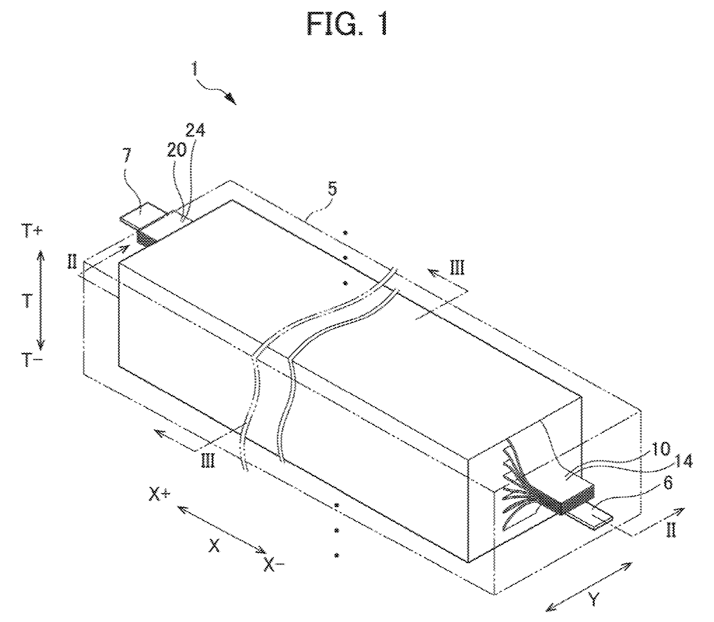

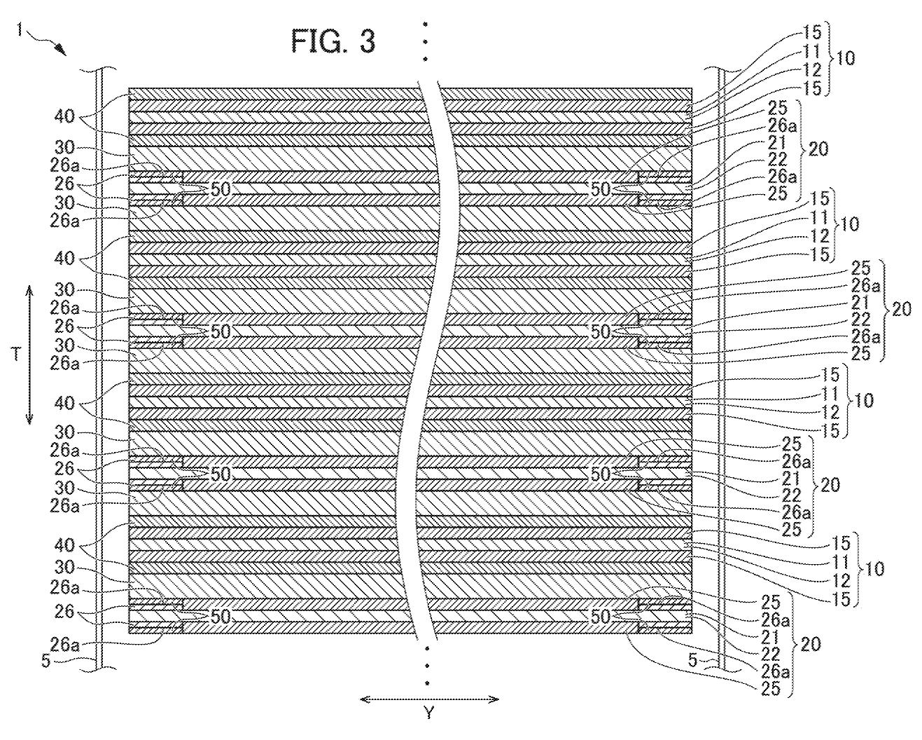

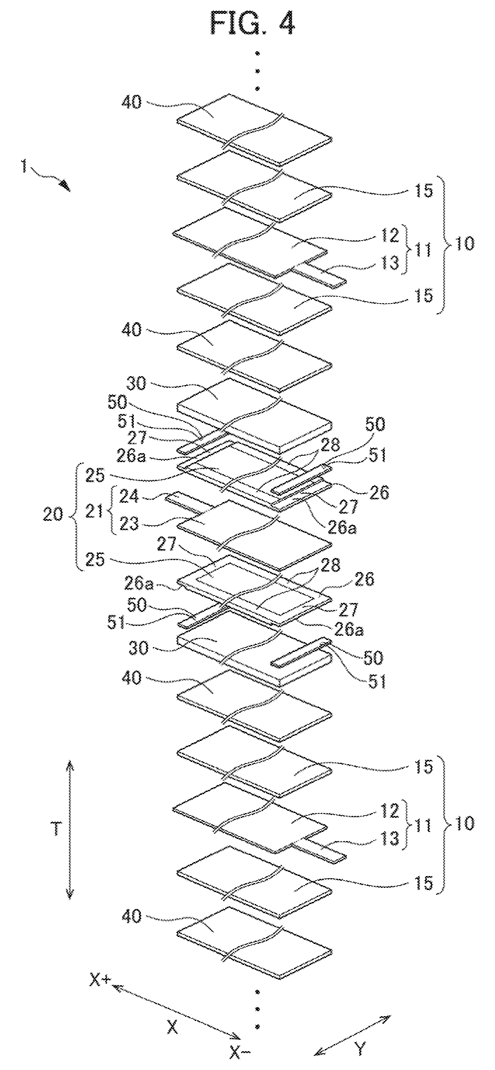

An all-solid-state battery 1 according to an embodiment of the present invention will be described below. The all-solid-state battery 1 may be of any type without particular limitation, and is, for example, an all-solid-state lithium battery that includes lithium ions as a charge transfer medium. As illustrated in FIGS. 1 to 4, the all-solid-state battery 1 has a structure in which positive electrode layers 20 and negative electrode layers 10 are laminated with solid electrolyte layers 30 interposed therebetween.

In the present specification, a direction in which the positive electrode layers 20 and the negative electrode layers 10 are laminated with the solid electrolyte layers 30 interposed therebetween is referred to as a "T direction". The T direction corresponds to a laminating direction. One direction among directions orthogonal to the T direction is referred to as an "X direction". The X direction corresponds to a first direction. A direction orthogonal to the T direction and the X direction is referred to as a "Y direction". The Y direction corresponds to a second direction. A direction toward one side in the X direction is referred to as an "X+ direction", and a direction opposite to the X+ direction is referred to as an "X- direction".

### All-Solid-State Battery

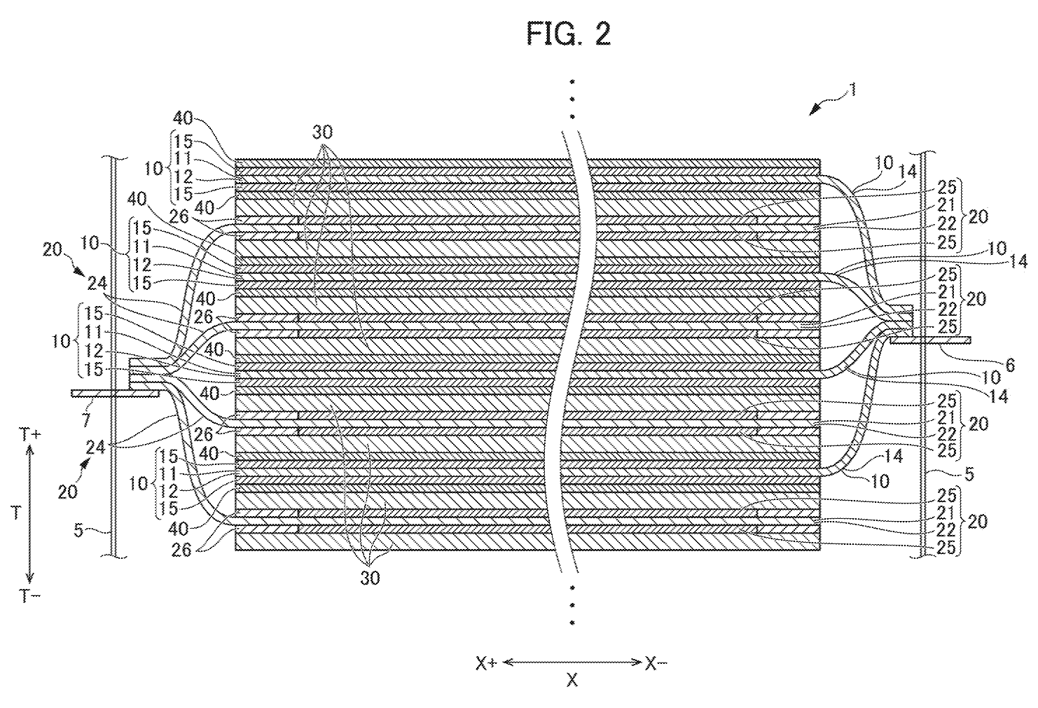

The all-solid-state battery 1 includes, for example, the plurality of negative electrode layers 10, the plurality of solid electrolyte layers 30, and the plurality of positive electrode layers 20. One negative electrode layer 10, one solid electrolyte layer 30, one positive electrode layer 20, and another solid electrolyte layer 30 are laminated in this order. The total number of laminated negative electrode layers 10 and positive electrode layers 20 is not particularly limited, and is preferably ten or more. It should be noted that in FIGS. 2 to 4, illustration of portions near the ends of the all-solid-state battery 1 in the T direction is omitted.

The all-solid-state battery 1 includes an exterior 5, a negative electrode tab lead 6, and a positive electrode tab lead 7. The exterior 5 forms a surface of the all-solid-state battery 1. The exterior 5 covers the laminate of the negative electrode layers 10, the solid electrolyte layers 30, and the positive electrode layers 20. The exterior 5 is composed of, for example, a resin. In FIG. 1, the exterior 5 is indicated by the two-dot chain lines. The negative electrode tab lead 6 is connected to bundled negative electrode tabs 14 (described later). The negative electrode tab lead 6 extends out from the exterior 5. The positive electrode tab lead 7 is connected to bundled positive electrode tabs 24 (described later). The positive electrode tab lead 7 extends out from the exterior 5.

### Negative Electrode Layer

Each negative electrode layer 10 includes a negative electrode active material layer 15 and a negative electrode current collector layer 11. Specifically, for example, one negative electrode layer 10 includes one negative electrode current collector layer 11 and two negative electrode active material layers 15 sandwiching the one negative electrode current collector layer 11 in the T direction.

The negative electrode active material layers 15 include a negative electrode active material. Examples of the negative electrode active material include, but are not limited to, lithium metal, lithium alloy, silicon (Si), silicon-based active materials such as silicon alloy, lithium transition metal oxides such as lithium titanate (Li₄Ti₅O₁₂), transition metal oxides such as TiO₂, Nb₂O₃, and WO₃, metal sulfides, metal nitrides, carbon materials such as graphite, soft carbon, and hard carbon, and metal indium. The negative electrode active material layers 15 are preferably composed of lithium metal. The negative electrode active material layers 15 may further include a solid electrolyte, a conductive aid, a binder, and the like.

Each negative electrode active material layer 15 has, for example, a flat plate shape with a plate surface extending in the X direction and the Y direction. When viewed in the T direction, the negative electrode active material layer 15 has a rectangular shape with a long side extending in the X direction, for example.

The negative electrode current collector layer 11 is provided adjacent to the negative electrode active material layers 15. The negative electrode current collector layer 11 is composed of, for example, copper, but is not limited to copper. The negative electrode current collector layer 11 has, for example, a foil shape. The negative electrode current collector layer 11 includes a negative electrode current collector layer-main body 12 and a negative electrode tab 14.

The negative electrode current collector layer-main body 12 is a portion of the negative electrode current collector layer 11 that overlaps with the adjacent negative electrode active material layers 15 in the T direction. When viewed in the T direction, the negative electrode current collector layer-main body 12 has a substantially rectangular shape with a long side extending in the X direction, for example.

The negative electrode tab 14 is a portion of the negative electrode current collector layer 11 that extends from the negative electrode current collector layer-main body 12 in a predetermined direction. The negative electrode tab 14 extends, for example, from the negative electrode current collector layer-main body 12 toward one side in the X direction (specifically, in the X- direction). The negative electrode tab 14 has a smaller dimension in the Y direction than the negative electrode current collector layer-main body 12. When viewed in the T direction, the negative electrode tab 14 has a substantially rectangular shape with a long side extending in the X direction, for example. The leading end portions of the plurality of negative electrode tabs 14 are bundled together.

### Solid Electrolyte Layer

The solid electrolyte layer 30 is provided between the negative electrode layer 10 and the positive electrode layer 20. The solid electrolyte layer 30 contains a solid electrolyte material. Examples of the solid electrolyte material include, but are not limited to, a sulfide solid electrolyte material and an oxide solid electrolyte material.

### Positive Electrode Layer

Each positive electrode layer 20 includes a positive electrode active material layer 25 and a positive electrode current collector layer 21. Specifically, for example, one positive electrode layer 20 includes one positive electrode current collector layer 21 and two positive electrode active material layers 25 sandwiching the one positive electrode current collector layer 21 in the T direction.

The positive electrode active material layers 25 include a positive electrode active material. Examples of the positive electrode active material include, but are not limited to, transition metal chalcogenides such as titanium disulfide, molybdenum disulfide, and niobium selenide, and transition metal oxides such as lithium nickelate (LiNiO₂), lithium manganate (LiMnO₂, LiMn₂O₄), and lithium cobaltate (LiCoO₂). The positive electrode active material layers 25 may further include a solid electrolyte, a conductive aid, a binder, and the like.

Each positive electrode active material layer 25 has, for example, a flat plate shape with a plate surface extending in the X direction and the Y direction. When viewed in the T direction, the positive electrode active material layer 25 has a rectangular shape with a long side extending in the X direction, for example.

An insulating layer 26 is provided along an outer periphery of each positive electrode active material layer 25.

The insulating layer 26 includes a material having electronic insulation properties. Examples of the material having electronic insulation properties include, but are not limited to, insulating oxides such as alumina, resins such as polyvinylidene fluoride (PVDF), and rubbers such as styrene-butadiene rubber (SBR). The insulating layer 26 is preferably composed of alumina. The insulating layer 26 may have ionic conductivity.

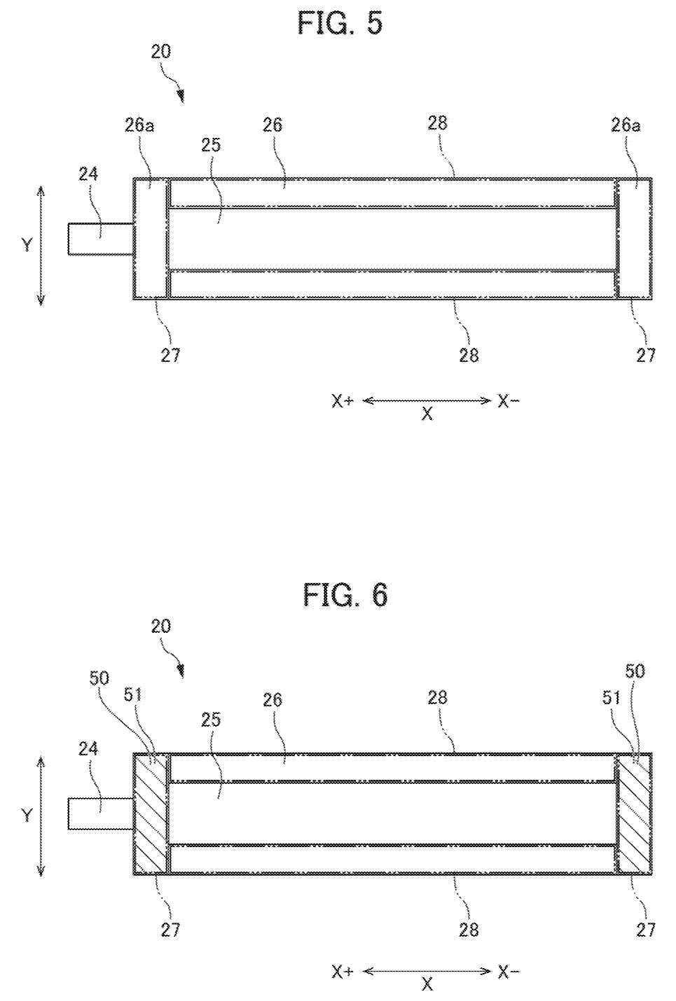

The insulating layer 26 has a substantially flat plate shape with a plate surface extending in the X direction and the Y direction. When viewed in the T direction, the insulating layer 26 has a substantially rectangular frame shape with a long side extending in the X direction, for example (see FIG. 5). The insulating layer 26 has, for example, a pair of first side portions 27 opposite to each other in the X direction and a pair of second side portions 28 opposite to each other in the Y direction and sandwiched between the first side portions 27.

Each first side portion 27 has a strip shape the long-side direction of which corresponds to the Y direction when viewed in the T direction. Each second side portion 28 has a strip shape the long-side direction of which corresponds to the X direction when viewed in the T direction. The dimension in the long-side direction of the first side portion 27 is smaller than the total value of the dimension in the short-side direction of the first side portion 27 and the dimension in the long-side direction of the second side portion 28. The dimension in the long-side direction of the first side portion 27 is, for example, smaller than the dimension in the long-side direction of the second side portion 28.

The insulating layer 26 is capable of suppressing a short circuit in the all-solid-state battery 1 and improving strength of the all-solid-state battery 1.

The positive electrode current collector layer 21 is provided adjacent to the positive electrode active material layers 25. The positive electrode current collector layer 21 is composed of a current collector. Examples of the current collector include, but are not limited to, aluminum, copper, nickel, vanadium, iron, titanium, stainless steel, gold, platinum, and carbon. The positive electrode current collector layer 21 is composed of aluminum, for example. The positive electrode current collector layer 21 has, for example, a foil shape. The positive electrode current collector layer 21 includes a positive electrode current collector layer-main body 22 and a positive electrode tab 24.

The positive electrode current collector layer-main body 22 is a portion of the positive electrode current collector layer 21 that overlaps in the T direction with the positive electrode active material layer 25 adjacent to the positive electrode current collector layer 21. More specifically, the positive electrode current collector layer-main body 22 is a portion that overlaps in the T direction with at least one of the two positive electrode active material layers 25 adjacent to the positive electrode current collector layer 21. When viewed in the T direction, the positive electrode current collector layer-main body 22 has a rectangular shape with a long side extending in the X direction, for example.

In the case where the insulating layer 26 is provided along the positive electrode active material layer 25, "a portion of the positive electrode current collector layer 21 that overlaps in the T direction with the positive electrode active material layer 25 adjacent to the positive electrode current collector layer 21" refers to a portion of the positive electrode current collector layer 21 that overlaps in the T direction with at least one of the positive electrode active material layer 25 adjacent to the positive electrode current collector layer 21 or the insulating layer 26 provided along the outer periphery of the positive electrode active material layer 25.

The positive electrode tab 24 is a portion of the positive electrode current collector layer 21 that extends from the positive electrode current collector layer-main body 22 in a predetermined direction. The positive electrode tab 24 extends, for example, from the positive electrode current collector layer-main body 22 toward one side in the X direction (specifically, in the X+ direction). The positive electrode tab 24 has a smaller dimension in the Y-direction than the positive electrode current collector layer-main body 22. When viewed in the T direction, the positive electrode tab 24 has a substantially rectangular shape with a long side extending in the X direction, for example. The leading end portions of the plurality of positive electrode tabs 24 are bundled together.

### Intermediate Layer

The all-solid-state battery 1 further includes, for example, a plurality of intermediate layers 40 each provided between the negative electrode layer 10 and the solid electrolyte layer 30 that are adjacent to each other.

The intermediate layers 40 include, for example, carbon carrying a metal that is capable of alloying with lithium. A non-limiting example of the metal capable of alloying with lithium is silver. Each intermediate layer 40 has, for example, a substantially rectangular plate shape with a plate surface extending in the X direction and the Y direction.

The intermediate layers 40 are more flexible than the negative electrode layers 10 and the solid electrolyte layers 30, and therefore, are easily brought into tight contact with the negative electrode layers 10 and the solid electrolyte layers 30. The intermediate layers 40 are capable of suppressing delamination between the negative electrode layer 10 and the solid electrolyte layer 30.

### Adhesive Layer

The all-solid-state battery 1 further includes adhesive layers 50 each provided between the insulating layer 26 and the solid electrolyte layer 30 that are adjacent to each other.

Each adhesive layer 50 is in contact with both the insulating layer 26 and the solid electrolyte layer 30. The adhesive layers 50 have, for example, adhesiveness. The adhesive layers 50 are configured as a double-sided tape, which is a non-limiting example. The adhesive layers 50 may be composed of resin, rubber, or the like. The adhesive layers 50 may be composed of, for example, an insulating material such as styrene butadiene rubber (SBR), polytetrafluoroethylene (PTFE), polyimide, UV curable resin, or the like. The adhesive layers 50 are preferably more flexible than the insulating layers 26. The adhesive layers 50 are preferably more flexible than the solid electrolyte layers 30. In that case, the adhesion between the adhesive layer 50 and the insulating layer 26 and the adhesion between the adhesive layer 50 and the solid electrolyte layer 30 can be improved.

The insulating layer 26 has the first side portions 27 extending in the Y direction and the second side portions 28 extending in the X direction, for example. The adhesive layer 50 is preferably provided at least on the first side portion 27.

The adhesive layer 50 has, for example, a flat plate shape with a plate surface extending in the X direction and the Y direction. When viewed in the T direction, the adhesive layer 50 has a strip shape extending in the Y direction, for example. While each first side portion 27 has surfaces opposite to each other in the T direction, the adhesive layer 50 is provided, for example, over the entire area of the surface of the first side portion 27 facing the solid electrolyte layer 30. The adhesive layer 50 is provided, for example, on both of a pair of first side portions 27.

As illustrated in FIG. 6, the adhesive layer 50 is provided, for example, only on the first side portions 27 of the insulating layer 26. The adhesive layer 50 is not provided, for example, on the second side portions 28. The adhesive layer 50 is not provided on the positive electrode active material layer 25.

A recessed portion 26a that is recessed in the T direction may be formed in a portion of the insulating layer 26 that overlaps with the adhesive layer 50 in the T direction. The depth of the recessed portion 26a (in other words, the dimension in the T direction of the recessed portion 26a) is substantially the same as the dimension in the T direction of the adhesive layer 50. One surface of the adhesive layer 50 that is opposite to the other surface in the T direction and faces the solid electrolyte layer 30 is substantially flush with one surface of the positive electrode active material layer 25 that is opposite to the other surface in the T direction and faces the solid electrolyte layer 30. Due to this configuration, the positive electrode active material layer 25 can be brought into contact with the solid electrolyte layer 30 in a state in which the adhesive layer 50 is in contact with the solid electrolyte layer 30, thereby facilitating the transfer of electrons between the positive electrode active material layer 25 and the solid electrolyte layer 30.

The dimension in the T direction of the recessed portion 26a is preferably 65% or more and 100% or less of the dimension in the T direction of the insulating layer 26. The dimension in the T direction of the adhesive layer 50 is preferably 5% or more and 40% or less of the dimension in the T direction of the insulating layer 26. In a case where the dimension in the T direction of the insulating layer 26 is small, the strength of the insulating layer 26 may decrease. In a case where the dimension in the T direction of the adhesive layer 50 is small, the strength of the adhesive layer 50 may decrease. Setting the foregoing dimensions in the T direction within the ranges described above makes it possible to ensure the strength of the adhesive layer 50 while ensuring the strength of the insulating layer 26.

### Method of Manufacturing All-Solid-State Battery

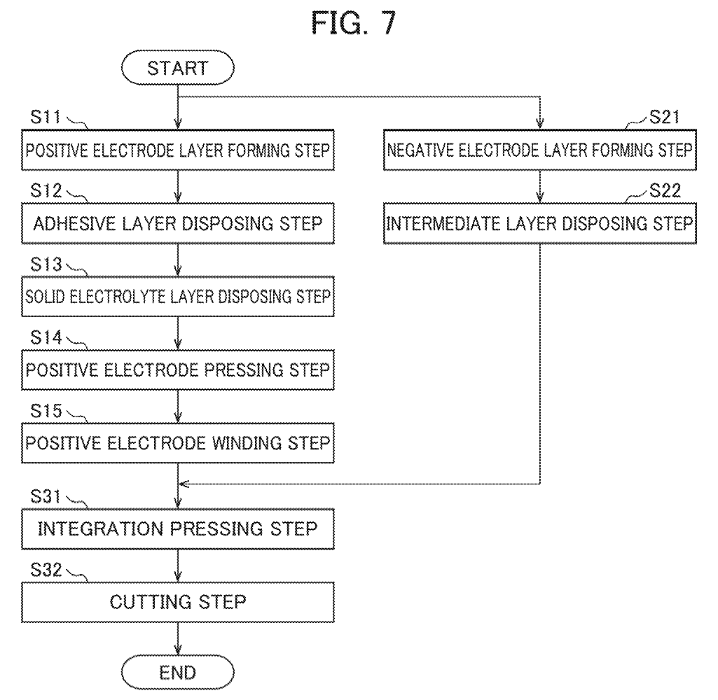

Next, a method of manufacturing the all-solid-state battery 1 according to the embodiment will be described with reference to FIG. 7. In the present embodiment, a case in which the all-solid-state batteries 1 are manufactured by means of a roll-to-roll production line in which the positive electrode current collector layers 21 are prepared from a long sheet-shaped positive electrode current collector layer 21 wound around a roll will be described.

First, the positive electrode layer 20 is formed by laminating the positive electrode current collector layer 21 and the positive electrode active material layer 25 on each other (positive electrode layer forming step S11). In the positive electrode layer forming step S11, the long sheet-shaped positive electrode current collector layer 21 wound around the roll is fed out by a conveying roller, and a positive electrode active material is applied to the long sheet-shaped positive electrode current collector layer 21 being conveyed, thereby forming the positive electrode active material layers 25. The positive electrode active material layers 25 are formed at intervals in accordance with the design dimensions of the all-solid-state battery 1 in finished form. As a result, a continuous body of positive electrode layers, which is the long sheet-shaped positive electrode current collector layer 21 having the plurality of positive electrode active material layers 25 formed thereon at intervals, is obtained. Next, the insulating layer is formed along an outer periphery of each positive electrode active material layer 25. In this step, each insulating layer 26 is formed on the positive electrode current collector layer 21 of the positive electrode layer 20 in accordance with the design dimensions of the all-solid-state battery 1 in finished form. As a result, a continuous body of insulating layer-equipped positive electrode layers is obtained. The recessed portions 26a may be formed at positions of the insulating layers 26 where the adhesive layer 50 is to be disposed. The positive electrode tabs 24 of the positive electrode current collector layers 21 may be formed, for example, before winding the long sheet-shaped positive electrode current collector layer 21 around the roll. The positive electrode layer forming step corresponds to a preparation step.

Next, the adhesive layer 50 is disposed on each insulating layer 26 (adhesive layer disposing step S12). In the adhesive layer disposing step S12, for example, an adhesive tape that serves as the adhesive layer 50 is transferred onto the insulating layer 26. The adhesive layer 50 is disposed at least on the first side portions 27. For example, the adhesive layer 50 is disposed only on the first side portions 27. Alternatively, a resin or the like that serves as the adhesive layer 50 may be applied to the insulating layer 26.

Next, a long sheet-shaped solid electrolyte layer 30 is laminated on the continuous body of the positive electrode layers 20 having the insulating layers 26 (solid electrolyte layer disposing step S13). In the solid electrolyte layer disposing step S13, a solid electrolyte layer transfer sheet, which is a long carrier sheet having the solid electrolyte layer 30 removably laminated thereon, can be used. The solid electrolyte layer 30 of the solid electrolyte layer transfer sheet is pressed onto the positive electrode layers 20 of the continuous body of the positive electrode layers 20 having the insulating layers 26 by using a transfer roller, and thereafter, the long carrier sheet is peeled off, whereby the solid electrolyte layer 30 is transferred. The transfer roller presses the continuous body of the positive electrode layers 20 having the insulating layers 26 and the long sheet-shaped solid electrolyte layer 30 while conveying them in the Y direction. The adhesive layer 50 is interposed between the solid electrolyte layer 30 and the insulating layer 26. In this step, for example, the temperature is set to room temperature (e.g., 10°C to 35°C), and the pressure is set to 50 MPa to 500 MPa.

Next, the continuous body of the positive electrode layers 20 having the insulating layers 26, on which the solid electrolyte layers 30 are laminated, is pressed (positive electrode pressing step S14). The positive electrode pressing step S14 densifies the positive electrode layers 20. In order to densify the positive electrode layers 20, the positive electrode pressing step S14 is carried out at a temperature of 25°C to 200°C and a pressure of 800 MPa to 1200 MPa, for example. Furthermore, the positive electrode pressing step S14 can enhance adhesion between the adhesive layer 50 and the insulating layer 26 and adhesion between the adhesive layer 50 and the solid electrolyte layer 30.

Next, the laminate composed of the continuous body of positive electrode layers 20 and the long sheet-shaped solid electrolyte layer 30 is wound around a roll (positive electrode winding step S15). In the positive electrode winding step S15, the laminate, which is composed of the continuous body of positive electrode layers 20 having the insulating layers 26 and the long sheet-shaped solid electrolyte layer 30 that are laminated with the adhesive layer 50 interposed between the insulating layers 26 and the long sheet-shaped solid electrolyte layer 30, is wound around a roll.

On the other hand, the negative electrode layer 10 is formed by disposing the negative electrode active material layer 15 on the negative electrode current collector layer 11 (negative electrode layer disposing step S21). In the negative electrode layer disposing step S21, a long sheet-shaped negative electrode current collector layer 11 wound around a roll is fed out by a conveying roller, and a negative electrode active material is applied to the long sheet-shaped negative electrode current collector layer 11 being conveyed. The negative electrode tabs 14 of the negative electrode current collector layer 11 are formed, for example, before winding the long sheet-shaped negative electrode current collector layer 11 around the roll.

Next, a long sheet-shaped intermediate layer 40 is disposed on the negative electrode active material layer 15 laminated on the long sheet-shaped negative electrode current collector layer 11 (intermediate layer disposing step S22). In the intermediate layer disposing step S22, transfer pressing is performed such that for example, the long sheet-shaped intermediate layer 40 is pressed on and applied to the negative electrode active material layer 15 by using a transfer roller. In this step, for example, the temperature is set to room temperature (e.g., 10°C to 35°C), and the pressure is set to 50 MPa to 500 MPa.

Thereafter, the continuous body of positive electrode layers 20 having the long sheet-shaped solid electrolyte layer 30 laminated thereon and the long sheet-shaped negative electrode layer 10 having the long sheet-shaped intermediate layer 40 laminated thereon are superposed together such that the long sheet-shaped solid electrolyte layer 30 and the long sheet-shaped intermediate layer 40 are sandwiched therebetween, and the resultant superposed layers are pressed by a pressing device (integration pressing step S31). Thus, as a result of the integration pressing, the long sheet-shaped negative electrode 10 is laminated over a side of the long sheet-shaped solid electrolyte layer 30 opposite to the continuous body of positive electrode layers 20, and the continuous body of positive electrode layers 20, the long sheet-shaped negative electrode layer 10, the long sheet-shaped solid electrolyte layer 30, the long sheet-shaped intermediate layer 40, and the adhesive layer 50 are integrated. In this step, for example, the temperature is set to 25°C to 100°C, and the pressure is set to 500 MPa to 900 MPa. The integration pressing step S31 integrates the continuous body of positive electrode layers 20, the long sheet-shaped negative electrode layer 10, the long sheet-shaped solid electrolyte layer 30, and the adhesive layer 50, and densifies the long sheet-shaped solid electrolyte layer 30.

The pressing pressure in the positive electrode pressing step S14 is higher than the pressing pressure in the integration pressing step S31.

Next, the resultant laminate is cut with a rotary cutter (cutting step S32).

Next, although not illustrated, leading end portions of the plurality of negative electrode tabs 14 are bundled and connected to the negative electrode tab lead 6. Leading end portions of the plurality of positive electrode tabs 24 are bundled and connected to the negative electrode tab lead 6. Next, the laminate is covered with a resin that serves as the exterior 5. A leading end portion of the positive electrode tab lead 7 and a leading end portion of the negative electrode tab lead 6 are exposed from the exterior 5.

The transfer of the solid electrolyte layer 30 to the positive electrode layer 20 in the solid electrolyte layer disposing step S13, the pressing of the positive electrode layer 20 in the positive electrode pressing step S14, the lamination of the negative electrode layer 10 on the positive electrode layer 20 before the integration, and the integration pressing in the integration pressing step S31 are performed on both surfaces of the positive electrode layer 20. The transfer of the negative electrode active material layer 15 to the negative electrode current collector layer 11 in the negative electrode layer disposing step S21 and the transfer of the intermediate layer 40 to the negative electrode layer 10 in the intermediate layer disposing step S22 are performed on both surfaces of the negative electrode layer 10. As a result, the all-solid-state battery 1 has a structure in which each current collector layer has symmetrically laminated layers on the upper and lower surfaces, as illustrated in FIGS. 1 to 4.

By the method described above, the all-solid-state battery 1 illustrated in FIG. 1 is manufactured.

The method of manufacturing the all-solid-state battery 1 according to the present embodiment may include a step other than those described above. The method of manufacturing the all-solid-state battery is not limited to the above-described method, and a known method other than the above can be employed.

### Effects of Embodiment

The above-described embodiment exerts the following effects.

According to the above-described embodiment, the all-solid-state battery 1 includes the insulating layer 26 and the adhesive layer 50 that is provided between the insulating layer 26 and the solid electrolyte layer 30 adjacent to each other.

Due to this feature, in which the adhesive layer 50 is interposed between the insulating layer 26 and the solid electrolyte layer 30, the likelihood that the insulating layer 26 slips with respect to the solid electrolyte layer 30 can be reduced or eliminated. This makes it possible to reduce or eliminate the likelihood that the positional relationship between the solid electrolyte layer 30 and the positive electrode active material layer 25 deviates from an ideal positional relationship, whereby an increase in electrical resistance between the solid electrolyte layer 30 and the positive electrode active material layer 25 can be suppressed. Therefore, the all-solid-state battery 1 capable of improving battery characteristics can be provided.

Further, the deviation of the positional relationship between the solid electrolyte layer 30 and the positive electrode active material layer 25 caused by repeated expansion and contraction of the all-solid-state battery 1 can be prevented or reduced, whereby cycle characteristics of the all-solid-state battery 1 can be improved.

Further, the deviation of the positional relationship between the solid electrolyte layer 30 and the positive electrode active material layer 25 can be prevented or reduced during manufacturing of the all-solid-state battery, whereby yield can be improved.

According to the above-described embodiment, the insulating layer 26 is preferably composed of alumina.

According to this feature, since alumina is a material having low electrical conductivity, the insulation performance of the insulating layer 26 can be improved. This makes it possible to satisfactorily reduce or eliminate the likelihood of occurrence of a short circuit between the negative electrode layer 10 and the positive electrode layer 20 when the negative electrode layer 10 (negative electrode tab 14) is curved and comes into contact with the insulating layer 26.

In the case of being composed of alumina, the insulating layer 26 is relatively hard and may tend to slip with respect to the solid electrolyte layer 30. However, the action of the adhesive layer 50 reduces or eliminates the likelihood that the insulating layer 26 slips with respect to the solid electrolyte layer 30, whereby the use of alumina as a material for the insulating layer 26 can be facilitated.

According to the above-described embodiment, the positive electrode active material layer 25 has a long-side direction corresponding to the X direction. The insulating layer 26 has the first side portions 27 extending in the Y direction. The adhesive layer 50 is preferably provided between the first side portions 27 and the solid electrolyte layer 30.

This feature can sufficiently reduce or eliminate the likelihood that the solid electrolyte layer 30 slips with respect to the insulating layer 26. As a result, the likelihood that the positional relationship between the solid electrolyte layer 30 and the positive electrode layer 20 deviates from an ideal positional relationship can be sufficiently reduced or eliminated.

According to the above-described embodiment, the adhesive layer 50 is preferably provided only between the first side portions 27 and the solid electrolyte layer 30.

This feature makes it possible to reduce an amount of the adhesive layer 50 to be used, while sufficiently reducing or eliminating the likelihood that the solid electrolyte layer 30 slips with respect to the insulating layer 26.

The recessed portion 26a that is recessed in the T direction may be formed in a portion of the insulating layer 26 that overlaps with the adhesive layer 50 in the T direction.

Due to this feature, the positive electrode active material layer 25 can be easily brought into contact with the solid electrolyte layer 30 in a state in which the adhesive layer 50 is in contact with the solid electrolyte layer 30, thereby facilitating the transfer of electrons between the positive electrode active material layer 25 and the solid electrolyte layer 30.

The dimension in the T direction of the recessed portion 26a is preferably 65% or more and 100% or less, and more preferably 5% or more and 40% or less of the dimension in the T direction of the insulating layer 26.

When the dimension in the T direction of the insulating layer 26 is small, the strength of the insulating layer 26 may decrease. When the dimension in the T direction of the adhesive layer 50 is small, the strength of the adhesive layer 50 may decrease. In contrast, the above feature makes it possible to ensure both the strength of the insulating layer 26 and the strength of the adhesive layer 50.

According to the above-described embodiment, the method of manufacturing the all-solid-state battery 1 includes the positive electrode layer forming step S11 of preparing an insulating layer-equipped positive electrode layer, which is composed of the positive electrode layer 20 including the positive electrode active material layer 25 and the insulating layer 26 provided along the outer periphery of the positive electrode active material layer 25, the adhesive layer disposing step S12 of disposing the adhesive layer 50 on a surface of the insulating layer 26, the solid electrolyte layer disposing step S13 of laminating the solid electrolyte layer 30 on a surface of the positive electrode layer 20 having the insulating layer 26, and the integration pressing step S31 of laminating the negative electrode layer 10 over a side of the solid electrolyte layer 30 opposite to the positive electrode layer 20.

According to this manufacturing method, the insulating layer 26 is disposed on the surface of the positive electrode layer 20 to form the positive electrode layer 20 having the insulating layer 26, and the solid electrolyte layer 30 is disposed on the surface of the positive electrode layer 20 having the insulating layer 26, whereby the likelihood that the positional relationship between the solid electrolyte layer 30 and the positive electrode active material layer 25 deviates from an ideal positional relationship can be reduced or eliminated. As a result, an increase in electrical resistance between the solid electrolyte layer 30 and the positive electrode active material layer 25 can be suppressed, whereby the provided method of manufacturing the all-solid-state battery 1 is capable of improving battery characteristics.

According to the above-described embodiment, in the adhesive layer disposing step S12, the adhesive layer 50 is disposed at least on the first side portions 27.

By way of this manufacturing method, the all-solid-state battery 1 capable of sufficiently reducing or eliminating the likelihood that the solid electrolyte layer 30 slips with respect to the insulating layer 26 can be manufactured.

According to the above embodiment, in the adhesive layer disposing step S12, the adhesive layer 50 is disposed only on the first side portions 27.

This manufacturing method makes it possible to reduce an amount of the adhesive layer 50 to be used, while manufacturing the all-solid-state battery 1 capable of sufficiently reducing or eliminating the likelihood that the solid electrolyte layer 30 slips with respect to the insulating layer 26.

According to the above-described embodiment, the method of manufacturing the all-solid-state battery 1 includes the positive electrode winding step S15 of winding, around a roll, a laminate including the solid electrolyte layer 30 and the positive electrode layer 20 having the insulating layer 26 and that are laminated with the adhesive layer 50 interposed between the insulating layer 26 and the solid electrolyte layer 30.

According to this manufacturing method, the all-solid-state battery 1 can be efficiently manufactured. On the other hand, in a case of winding the laminate of the solid electrolyte layer 30 and the positive electrode layer 20 around a roll in order to manufacture a plurality of all-solid-state batteries, if the positional relationship between the solid electrolyte layer 30 and the positive electrode layer 20 deviates from an ideal positional relationship, it may become difficult to wind the laminate of the solid electrolyte layer 30 and the positive electrode layer 20 around the roll. However, by interposing the adhesive layer 50 between the insulating layer 26 and the solid electrolyte layer 30, the deviation of the positional relationship between the solid electrolyte layer 30 and the positive electrode layer 20 can be prevented or reduced by the adhesive layer 50, whereby the laminate of the solid electrolyte layer 30 and the positive electrode layer 20 can be easily wound around the roll. This makes it possible to manufacture the all-solid-state battery 1 more efficiently.

### Modifications of Embodiment

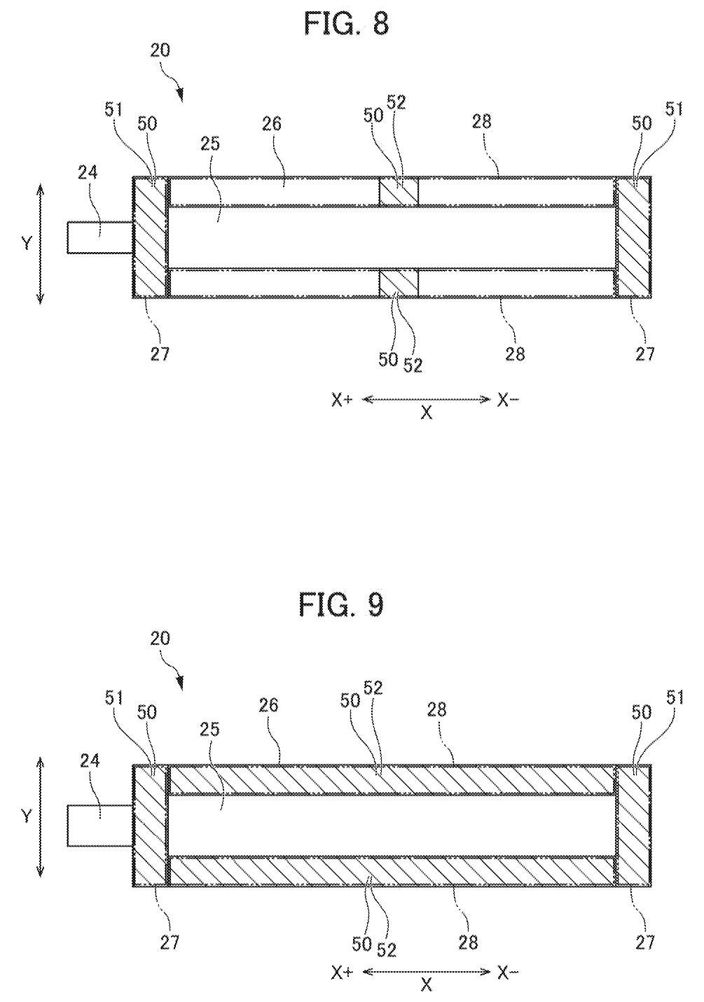

As illustrated in FIGS. 8 and 9, the adhesive layer 50 may be disposed between each first side portion 27 and the solid electrolyte layer 30 and between each second side portion 28 and the solid electrolyte layer 30. In the present specification, the adhesive layer 50 disposed on the first side portion 27 may be referred to as "adhesive layer 50a". The adhesive layer 50 disposed on the second side portion 28 may be referred to as "adhesive layer 50b".

This configuration makes it possible to more reliably eliminate or reduce the likelihood that the solid electrolyte layer 30 slips with respect to the insulating layer 26.

For example, the adhesive layer 50b may be provided only on a part the second side portion 28 in the X direction in a region between the second side portion 28 and the solid electrolyte layer 30 (see FIG. 8). The adhesive layer 50b disposed between the second side portion 28 and the solid electrolyte layer 30 may be spaced apart from each first side portion 27, and more specifically, may be disposed in a middle portion in the X direction in the region between the second side portion 28 and the solid electrolyte layer 30.

The adhesive layer 50b disposed in the region between the second side portion 28 and the solid electrolyte layer 30 may extend over the entire region between the second side portion 28 and the solid electrolyte layer 30 (see FIG. 9). The adhesive layer 50 may be provided over the entire region between the insulating layer 26 and the solid electrolyte layer 30. In the adhesive layer disposing step S12, the adhesive layer 50 may be disposed on the second side portions 28.

This configuration makes it possible to more reliably eliminate or reduce the likelihood that the solid electrolyte layer 30 slips with respect to the insulating layer 26.

The adhesive layer 50a may be disposed in any range of the first side portion 27 without particular limitation, and it is simply required to sufficiently prevent or reduce positional deviation between the solid electrolyte layer 30 and the positive electrode layer 20.

Further, the adhesive layer 50 may be spaced apart from the outer peripheral edge of the insulating layer 26. In that case, when the negative electrode tab 14 is bent, contact between the negative electrode tab 14 and the adhesive layer 50 can be prevented or reduced by the insulating layer 26. The adhesive layer 50 is preferably spaced apart from the positive electrode active material layer 25.

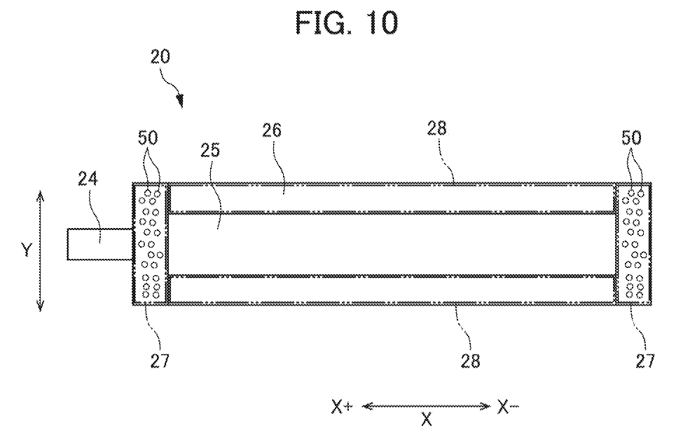

As illustrated in FIG. 10, the adhesive layer 50 may be disposed in the shape of dots (in other words, in the shape of granules).

This configuration makes it possible to reduce an amount of the adhesive layer 50 to be used, while sufficiently eliminating or reducing the likelihood that the solid electrolyte layer 30 slips with respect to the insulating layer 26.

A plurality of dots of adhesive layer 50 are disposed on the insulating layer 26. The dots of the adhesive layers 50 are preferably provided at least on the first side portions 27.

In the above-described embodiment and the modifications, the adhesive layer 50 is disposed in at least the region between each first side portion 27 and the solid electrolyte layer 30 in the region between the insulating layer 26 and the solid electrolyte layer 30, but it is possible that the adhesive layer 50 is provided only in the region between each second side portion 28 and the solid electrolyte layer 30 of the region between the insulating layer 26 and the solid electrolyte layer 30. However, disposing the adhesive layer 50 in the region between each first side portion 27 and the solid electrolyte layer 30 makes it possible to more efficiently eliminate or reduce the likelihood that the solid electrolyte layer 30 slips with respect to the insulating layer 26.

In the above-described embodiment and the modifications, the insulating layer 26 has a rectangular frame shape, but this is a non-limiting example. For example, the insulating layer may be devoid of the second side portions. The insulating layer may have a strip shape whose long-side direction corresponds to the Y direction and may be provided along an end edge in the X direction of the positive electrode active material layer 25. The insulating layer provided in this way can also prevent or reduce the occurrence of a short circuit due to contact between the positive electrode layer 20 and the negative electrode tab 14.

The present invention is not limited to the configuration of the above-described embodiment, and can be appropriately modified and worked within a range in which the spirit of the present invention is unchanged. It should be noted that a combination of two or more of the individual desirable configurations described in the above embodiment is also encompassed in the present invention.

What is claimed is:

1. An all-solid-state battery, comprising:
a negative electrode layer and a positive electrode layer laminated together with a solid electrolyte layer interposed therebetween, the positive electrode layer having a positive electrode active material layer;
an insulating layer provided along an outer periphery of the positive electrode active material layer; and
an adhesive layer provided between the insulating layer and the solid electrolyte layer that are adjacent to each other.

2. The all-solid-state battery according to claim 1, wherein the insulating layer is composed of alumina.

3. The all-solid-state battery according to claim 1, wherein
a direction in which the negative electrode layer and the positive electrode layer are laminated with the solid electrolyte layer interposed therebetween is defined as a laminating direction, one direction among directions orthogonal to the laminating direction is defined as a first direction, and a direction orthogonal to the laminating direction and the first direction is defined as a second direction,
the positive electrode active material layer has a long-side direction corresponding to the first direction,
the insulating layer has a first side portion extending in the second direction, and
the adhesive layer is provided at least between the first side portion and the solid electrolyte layer.

4. The all-solid-state battery according to claim 3, wherein the adhesive layer is provided only between the first side portion and the solid electrolyte layer.

5. The all-solid-state battery according to claim 3, wherein
the insulating layer has a second side portion that is adjacent to the first side portion in the first direction and extends in the first direction, and
the adhesive layer is provided between the second side portion and the solid electrolyte layer.

6. The all-solid-state battery according to claim 1, wherein the adhesive layer is disposed in a shape of a dot.

7. The all-solid-state battery according to claim 1, wherein
a direction in which the negative electrode layer and the positive electrode layer are laminated with the solid electrolyte layer interposed therebetween is defined as a laminating direction, and
a recessed portion that is recessed in the laminating direction is formed in a portion of the insulating layer that overlaps with the adhesive layer in the laminating direction.

8. The all-solid-state battery according to claim 7, wherein a dimension in the laminating direction of the recessed portion is 65% or more and 100% or less of a dimension in the laminating direction of the insulating layer.

9. A method of manufacturing the all-solid-state battery according to claim 1, the method comprising:
a preparation step including preparing an insulating layer-equipped positive electrode layer that has the positive electrode active material layer and the insulating layer provided along the outer periphery of the positive electrode active material layer;
an adhesive layer disposing step including disposing the adhesive layer on a surface of the insulating layer;
a solid electrolyte layer disposing step including laminating the solid electrolyte layer on a surface of the insulating layer-equipped positive electrode layer; and
a negative electrode layer disposing step including laminating the negative electrode layer over a side of the solid electrolyte layer opposite to the positive electrode layer.

10. The method according to claim 9, wherein
in the solid electrolyte layer disposing step, a direction in which the negative electrode layer and the positive electrode layer are laminated with the solid electrolyte layer interposed therebetween is defined as a laminating direction, one direction among directions orthogonal to the laminating direction is defined as a first direction, and a direction orthogonal to the laminating direction and the first direction is defined as a second direction,
the preparation step includes preparing the positive electrode active material layer having a long-side direction corresponding to the first direction and the insulating layer having a first side portion extending in the second direction, and
the adhesive layer disposing step includes disposing the adhesive layer at least on the first side portion.

11. The method according to claim 10, wherein
the adhesive layer disposing step includes disposing the adhesive layer only on the first side portion.

12. The method according to claim 10, wherein
the preparation step includes preparing the insulating layer-equipped positive electrode layer such that the insulating layer further has a second side portion adjacent to the first side portion in the first direction and extending in the first direction, and
the adhesive layer disposing step includes disposing the adhesive layer on the second side portion.

13. The method according to claim 9, further comprising:
a positive electrode winding step including winding, around a roll, a laminate including the solid electrolyte layer and the positive electrode layer having the insulating layer that are laminated with the adhesive layer interposed between the insulating layer and the solid electrolyte layer.

14. The method according to claim 9, further comprising:
a step including disposing an intermediate layer between the negative electrode layer and the solid electrolyte layer.
